(19) United States
(12) Patent Application Publication
(10) Pub. No.: US 2025/0131211 A1
(43) Pub. Date: Apr. 24, 2025

(54) IMPROVEMENT OF DIALECT TEXT CLASSIFICATION THROUGH DATA AUGMENTATION BASED ON N-GRAM CONVERSION TABLE

(71) Applicant: Sestek Ses ve Iletisim Bilgisayar Teknolojileri San. ve Tic. A.S., Istanbul (TR)

(72) Inventors: Mustafa ERDEN, Istanbul (TR); Ahmet BIRIM, Istanbul (TR)

(73) Assignee: Sestek Ses ve Iletisim Bilgisayar Teknolojileri San. ve Tic. A.S., Istanbul (TR)

(21) Appl. No.: 18/491,840

(22) Filed: Oct. 23, 2023

(51) Int. Cl. G06F 40/53; G06F 40/263

(52) U.S. Cl. CPC G06F 40/53; G06F 40/263

(57) ABSTRACT

A method of training a text classification model for intent detection in a language dialect is provided. A domain dataset for training the text classification model is obtained. The domain dataset is substantially in an official language, and the domain dataset contains n-grams in the official language which are extracted. A dialect language transformation table is created by providing equivalent dialect words in the language dialect for words in each extracted n-gram in the official language. The language transformation table is applied to the domain dataset to transform the domain dataset to create a hybrid dataset, which is added to the domain dataset to create an augmented dataset. A text classification model is trained on the augmented dataset to produce a trained text classification model for intent detection in a language dialect. The official language may be Modern Standard Arabic and the language dialect may be an Arabic dialect.

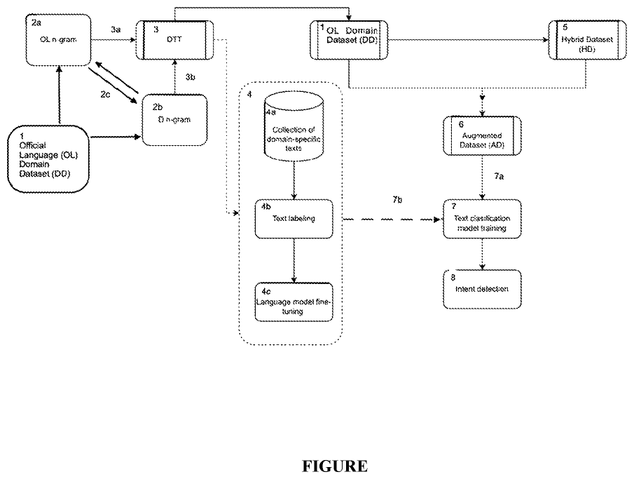

### TECHNICAL FIELD

The this disclosure is in the field of natural language processing. More specifically, this disclosure relates to natural language processing and intent detection of a dialect of an official language.

### BACKGROUND

Presently, companies and businesses in many sectors like financials, utilities, customer service, etc., deliver services to their customers remotely. Striking advancements in communication technology and AI have caused businesses to look for implementing smarter and high-performance systems that offer enhanced efficiency, rapid support, and personalized experiences while reducing costs. Thanks to the latest advancements in AI, these smart virtual assistants can now understand and respond to human interactions with great accuracy and context.

Chatbots are expected to interact with users by understanding their inquiries and generating suitable responses to them without the intervention of human agents (e.g., customer representatives). This can only be done by enabling chatbots to deal with users using human languages and to develop their ability to recognize and respond to their questions. As business activities expand, the linguistic and cultural diversity of the user base also increases. Usually, users communicate with the system in colloquial language (everyday language) rather than an official language during their interactions. Even though people in different regions may speak the same official language, they tend to communicate using their own dialect. Some dialects significantly differ from the official language. Therefore, it becomes increasingly necessary for chatbots to understand and support multiple languages along with their dialects.

Intent detection is crucial for chatbots as it enables them to understand the purpose or objective behind a user's message. By accurately identifying the user's intent, chatbots can provide more relevant and effective responses, enhancing the overall user experience.

The Arabic language is one of the most widely spoken languages globally, and it is also considered a very rich language in terms of dialects. In other words, it is natural to find multiple languages or dialects spoken in different regions of Arab countries. Modern Standard Arabic (MSA) is the formal and standardized version of the language, while dialects are regional or local variants of the Arabic language. There are multiple common and regional dialects in the Arab world. For example, the dialect spoken in Egypt is known as Egyptian Arabic, and the dialect spoken in Syria, Lebanon, Palestine, and Jordan is referred to as Levantine Arabic. Dialects are communication languages used in daily conversation, pronounced as they are written, and have different pronunciation and grammar structures compared to MSA. As a result, algorithms used for Natural Language Processing (NLP) in the Official Language (OL), i.e. MSA, are not effectively applicable for dialect processing. This study discusses the work done on Intent detection task in banking domain for OL and Palestinian dialect.

Intent detection is one of various tasks of text classification which is the process of categorizing a piece of text into pre-defined categories. This process can be done using traditional machine learning algorithms and deep learning. Text classification is particularly used to classify various forms of text, such as emails, articles, and messages in multiple languages including Arabic. However, machine learning models that are only trained on OL datasets fail to perform well in real-world applications, especially when encountering queries in different dialects. In such a situation when enough labeled and cleaned dialect data is available, then Machine Translation (MT) models can be trained to translate input dialect inquiries into the official language.

U.S. Patent Application Publication No. US 2022/0382999 A1 to Gunasekara et al. is directed to methods and systems for speech-to-speech translation. The system and method use a speech-to-text engine (STT engine), a text-to-text translation engine (TTT engine) and a text-to-speech conversion engine. In one example, the machine learning models of the STT engine are trained for other languages such as Farsi and Levantine Arabic. In Gunasekara et al., machine learning models of the STT engine may also be fine-tuned and trained specifically for different languages or dialects. Gunasekara et al. discloses that in the case of Levantine Arabic, it is possible to use a large Modern Standard Arabic (MSA) model with 1000 hours MSA data, then transfer the learning onto Levantine Arabic with 350 hours of Levantine Arabic data. Gunasekara et al. further in some examples subword transcripts may be used instead of word-level transcripts, using Byte Pair Encoding (BPE).

U.S. Pat. No. 11,366,965 B1 to Alshammari is directed to a method for performing sentiment analysis on Arabic text. The training text is preprocessed to remove non-Arabic characters, numbers, control characters or graphics. An annotator may label portions of the data such as words, terms, or phrases, as positive, neutral, or negative. A lexicon is formed based on the labeled training data. A bag-of-phrases is formed from the training text data, which is used to analyze the targeted data for sentiment. And based on the distribution of words or phrases, a sentiment is formed indicating a sentiment of each portion of the target data. By determination of the sentiment Alshammari can identify the specific language or dialect as well as an associated culture and/or domain associated with each portion of the data.

Although Machine Translation (MT) is a popular and widely used method, it fails to achieve the needed performance when data resources are limited. In general, it requires a substantial amount of high-quality parallel data (pairs of sentences in both dialect and official languages). Building such datasets can be challenging due to the lack of clean and annotated data for some languages or dialects. Additionally, the process of annotating vast amounts of data by experts is expensive and demands time and effort.

The current methods fail to adequately compensate for the drop in text classification models performance when dealing with low-resource dialect data without the need of adding any dialect data to the training dataset in the first place.

### SUMMARY

Usually, a model trained on OL expects to receive inquiries in the same language of data the model trained on. For example, a classification model trained on Turkish texts is expected to perform poorly on a new English query text. To overcome the performance decay, it is necessary to add examples in the expected dialect(s) to the training set. However, implementing this solution is not always easy or applicable. One of the reasons is the lack of clean and labeled data in dialect(s). In other words, there may not be enough reliable data available for training in the language's dialect(s) the model should respond to. As the number of data samples prepared for training increases, the system's recognition accuracy will also improve.

Within the scope of the invention, modeling has been conducted using augmented training and test datasets. Modern Standard Arabic (MSA) has been used for the representation of the Official Language (OL) in this invention. For the representation of the dialect language, for example, Palestinian Arabic can be used. In one embodiment, the banking domain was chosen for intent detection.

Obtaining a huge number of language dialect training texts can be challenging. Therefore, a transformation method is considered to create a hybrid dataset (HD) by leveraging text in the official language (OL). The method relies on creating a transformation table that includes equivalents of words and word groups in both OL and its dialect(s). Word groups having, or consisting of, 2, 3, and 4-word combinations occurring side by side in a text called n-grams. Utilizing a generated transformation table, OL training texts are partially translated into the dialect forming a HD as mentioned before. This way, instead of translating the whole input sentence in dialect, it is only done on a few words. By adding HD to OL, an augmented dataset (AD) is obtained on which an intent detection model is trained.

According to an exemplary embodiment of the invention a method of training a text classification model for intent detection of a dialect of a language is provided which includes steps of obtaining a domain dataset for training the text classification model, wherein the domain dataset is substantially in an official language. The domain dataset contains a plurality of n-grams in the official language, and a plurality of n-grams in the official language are extracted from the domain dataset. A dialect transformation table is created by providing equivalent words in the language dialect for words in each n-gram in the official language. The dialect transformation table is applied to the domain dataset to transform the domain dataset to create a hybrid dataset. The hybrid dataset is added to the domain dataset in the official language to create an augmented dataset. A text classification model is trained with the augmented dataset producing a trained text classification model for intent detection of the dialect of the language.

In a preferred embodiment the method further includes fine tuning a pre-trained language model using domain specific sentences adapted to the official language and the dialect language using the dialect transformation table.

In a further preferred embodiment, the step of fine tuning the pre-trained language model includes collecting domain specific sentences for training, then using the dialect transformation table, creating combinations of domain specific sentences by replacing matching words and n-grams in the sentences with corresponding ones from the dialect transformation table, wherein each pair of sentences is labeled as entailed sentences. Then, tuning the pre-trained language model for sentence entailment tasks by updating and adapting all parameters of the language model for the specific domain.

In a preferred embodiment of the method, the official language is Modern Standard Arabic and the dialect language is a dialect of Arabic.

In a further preferred embodiment of the method, the dialect language is Palestinian Arabic, Egyptian Arabic, Mesopotamian Arabic, Sudanese Arabic, Peninsular Arabic, Maghrebi Arabic, or Levantine Arabic.

In a further preferred embodiment of the method, the dialect language is Palestinian Arabic.

In a preferred embodiment of the invention each n-gram has a 2-, 3-, or 4-word combinations occurring side-by-side in a text of the domain dataset.

In a preferred embodiment the domain dataset comprises n-grams in the language dialect which are extracted from the domain dataset.

In a further preferred embodiment, the creating the dialect transformation table further provides equivalent official language words for words in each n-gram of the extracted plurality of n-grams in the language dialect.

In a preferred embodiment the text classification model is a fine tuned pre-trained language model.

In an embodiment of invention, a text classification model for intent detection in a language dialect is provided that is trained according to the method of obtaining a domain dataset for training the text classification model, wherein the domain dataset is substantially in an official language. The domain dataset contains a plurality of n-grams in the official language, and a plurality of n-grams in the official language are extracted from the domain dataset. A dialect transformation table is created by providing equivalent words in the language dialect for words in each n-gram in the official language. The dialect transformation table is applied to the domain dataset to transform the domain dataset to create a hybrid dataset. The hybrid dataset is added to the domain dataset in the official language to create an augmented dataset. A text classification model is trained with the augmented dataset producing a trained text classification model for intent detection of the dialect of the language.

In an embodiment of the invention, a non-transitory computer readable medium, comprising execution instruction is provided, so when a processor of an electronic device executes the instructions, the electronic device performs the method of obtaining a domain dataset for training the text classification model, wherein the domain dataset is substantially in an official language. The domain dataset in the official language contains a plurality of n-grams in the official language, and a plurality of n-grams in the official language are extracted from the domain dataset. A dialect transformation table is created by providing equivalent words in the language dialect for words in each n-gram in the official language. The dialect transformation table is applied to the domain dataset to transform the domain dataset to create a hybrid dataset. The hybrid dataset is added to the domain dataset in the official language to create an augmented dataset. A text classification model is trained with the augmented dataset producing a trained text classification model for intent detection of the dialect of the language.

In an embodiment of the invention an electronic device having a processor, a memory, and a bus, the memory is configured to store execution instructions, the processor and the memory are connected through the bus, and when the electronic device runs, the processor executes instructions stored in the memory to cause the processor to perform the method of obtaining a domain dataset for training the text classification model, wherein the domain dataset is substantially in an official language. The domain dataset in the official language contains a plurality of n-grams in the official language, and a plurality of n-grams in the official language are extracted from the domain dataset. A dialect transformation table is created by providing equivalent words in the language dialect for words in each n-gram in the official language. The dialect transformation table is applied to the domain dataset to transform the domain dataset to create a hybrid dataset. The hybrid dataset is added to the domain dataset in the official language to create an augmented dataset. A text classification model is trained with the augmented dataset producing a trained text classification model for intent detection of the dialect of the language.

By adding these hybrid sentences to the original ones, the model is exposed to some dialect data. We have discovered that exposing the model to dialect language will enhance the model's ability to better understand inquiries in all target dialect(s) and compensate for the decline in model performance in terms of accuracy of the detection of intent.

One of the advantages of this invention provides a novel methodology for approaching multiple text classification tasks, especially in languages with dialect(s). Another advantage of this invention is that a better intent detection model performance is obtained by only using a domain dataset available in the official language without the need to obtain a domain dataset in the language dialect.

### BRIEF DESCRIPTION OF THE FIGURE

The FIGURE shows a schematic of a method for generating a trained text classification model for intent detection in a language dialect.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. The computer-readable storage medium may be non-transitory. Furthermore, the sequence of actions described herein can be embodied in a combination of hardware and software. The method may be carried out on an electronic device having a processor, memory, and a bus or other communication link between the processor and memory. The memory of the electronic device may be configured to store execution instructions, and the processor and memory are connected through the bus or other communication link. When the electronic device runs the processor of the device may execute instructions stored in the memory to carry out a step or steps as set forth below. The various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

It is essential to consider the existing dialect(s) for a target language when developing solutions aiming to provide services for the increasing number of users around the world. Training models only on data available in the official language (OL) will result in poor-performing models on the dialect inquiries. In some cases, this is due to the big differences between the OL and its dialect(s) in some cases.

Usually, a model trained on OL expects to receive inquiries in the same language of data the model trained on. For example, a classification model trained on Turkish texts is expected to perform poorly on a new English query text. To overcome the performance decay, it is necessary to add examples in the expected dialect(s) to the training set. However, implementing this solution is not always easy or applicable. One of the reasons is the lack of clean and labeled data in dialect(s). In other words, there may not be enough reliable data available for training in the language's dialect(s) the model should respond to. As the number of data samples prepared for training increases, the system's recognition accuracy will also improve.

By this augmentation method, which constitutes a main content of the invention, is based on obtaining two parallel datasets of n-grams in both the official language and the Palestinian dialect. The method preferably is used in the classification of Arabic intent detection is a BERT-based classification method.

Since it may be difficult and time-consuming to obtain clean and structured data samples in multiple dialects for the purpose of model training in real life, a transformation-based method that enables the creation of a hybrid training set by making use of the Dialect Transformation Table (DTT) is considered. Using this transformation table, OL training texts were partially translated into dialect(s). By adding the resulting Hybrid Dataset (HD) to the OL training set, an Augmented Dataset (AD) was formed. Finally, a BERT-based model was fine-tuned on AD and tested on a dialect test set.

In an exemplary embodiment, modeling has been conducted using augmented training and test datasets. Modern Standard Arabic (MSA) has been used for the representation of the official language (OL) in this invention. For the representation of the dialect language, for example, Palestinian Arabic can be used. In this context, the banking domain was chosen for intent detection. And further the dialect may instead be Egyptian Arabic, Mesopotamian Arabic, Sudanese Arabic, Peninsular Arabic, Maghrebi Arabic, or Levantine Arabic. However, the method may be in any other language having different language dialects such as English, Spanish, French, etc. And the domain can be any field where users are likely to remotely request information and provide queries about products or services including but not limited to restaurants and dining, online shopping, shopping for a vehicle or scheduling vehicle maintenance, scheduling travel accommodations, or receiving technical support for a computer or a mobile device.

With reference to the FIGURE, the process begins by obtaining a domain dataset (DD) 1 to be used for training a text classification model. This dataset will mainly, or substantially, be in the official language (OL). The domain dataset may include any written text that is in the domain such as, but not limited to, technical manuals, articles, websites, white papers, FAQs, previously recorded inquiries and responses (e.g., between a prior user and a live troubleshooter). Next, the most frequent words and word groups (n-grams) are collected, or extracted, from the domain dataset providing the OL n-grams 2a. N-grams in the language dialect may be extracted, or collected, from the domain dataset if they are present and provide dialect(s) D n-grams 2b. The DTT is created in a parallel way 2c by collecting each set of n-grams in the official language 2a and then providing a corresponding n-gram in the dialect 2b, or, if an n-gram is in the dialect 2b, then providing an n-gram in the official language. A Dialect Transformation Table (DTT) 3 is created by using pairs of semantically corresponding words and n-grams already collected in 2a, 2b, and 2c.

Multiple ways can be followed to prepare the dialect transformation table (DTT) 3. For example, when enough unlabeled data is available, the most frequent words and n-grams in the relevant texts can be extracted. Obtaining parallel domain-specific n-gram list(s) with the assistance of some human experts can be considered a different approach. The dialect transformation table 3 is created by collecting or extracting the most frequent words and n-grams, in the official language (OL) and its Dialect(s) in a parallel way 2c (every word or n-gram in OL has its corresponding language dialect(s) word or n-gram). Each word in an n-gram may be translated to a corresponding dialect word to produce a dialect n-gram. Or alternatively an n-gram containing a phrase in the official language may be translated to a corresponding n-gram in the dialect having the same or similar meaning. The translation may be carried out in a number of ways. In one embodiment, the translation of an official language n-gram to a language dialect n-gram, or visa versa, can be carried out by a machine translation engine such as a translation algorithm, translation dictionary, language model, or trained natural language processing neural network. In another embodiment, the translation could also be carried out by a human translator or translators. For example, providing an official language n-gram on a computer, or over a computer network, to a native speaker or speakers of a language dialect and receiving an n-gram or set of n-grams back in the language dialect from the native speaker or speakers. A combination of machine translation and human translation can be used to produce the dialect transformation table 3. The corresponding pairs of n-grams in the official language 2a and the language dialect 2b are provided 3a, 3b to the DTT 3.

The dialect transformation table (DTT) 3 may have the official language n-grams 2a and a single set of language dialect n-grams 2b thereby representing the official language (OL) and one language dialect. Or the dialect transformation table (DTT) 3 may represent a plurality of language dialects, and for an official language n-gram in the dialect transformation table (DTT) 3, there may be more than one language dialect n-gram 2b provided for each language dialect represented in the dialect transformation table (DTT).

By applying dialect transformation table (DTT) 3 to the target domain dataset (DD) 1, the n-grams in the official language are substituted or augmented with the n-grams in the language dialect and a new set of hybrid sentences is obtained. As a result, each sentence of these newly generated sentences contains words and n-grams in both OL and the dialect forming what is called hybrid dataset (HD) 5. The hybrid dataset (HD) 5 contains partially translated textual data in language dialect. Then, the hybrid dataset is merged with the domain dataset (DD) 1 to form a new double-in-size dataset called augmented dataset (AD) 6. In the case where more than one language dialect is represented in the dialect transformation table (DTT) 3 the new augmented dataset (AD) 6 may be three times as large if two language dialects are represented, four times as large if three language dialects are represented. Alternatively, the augmented database (AD) may comprise the domain dataset (DD) 1 in the official language and only generated sentences where some translation according to the dialect transformation table (DTT) 3 has occurred in the hybrid dataset (HD) 5 and therefore be less than double-in-size of the domain dataset. Finally, an intent detection model 8 is trained using the Augmented Dataset (AD) 6. For training, any sort of text classification model trainer 7 can be used. In one exemplary embodiment Bidirectional Encoder Representations from Transformers (BERT) is used.

In an alternative embodiment, after the dialect transformation table (DTT) 3 is created, a pre-trained language model is fine-tuned 4 for sentence entailment using domain-specifics sentences adapted to the official language (OL) and its dialect using the DTT 3 as follows: domain-specific sentences 4a are collected for training; in one embodiment, the colleting may be performed by human translators who may be experts in the specific domain of field; using the dialect transformation table (DTT) 3, combinations of domain-specific sentences are created by replacing the matching words and n-grams in the sentences with their corresponding ones from the transformation table. Each pair of these sentences is labeled 4b as entailed sentences to be used later for fine-tuning; and in the fine-tuning step, a pre-trained language model is fine-tuned 4c for sentence entailment tasks. During the fine-tuning phase, all parameters of the language model, for instance sentence similarity labels in the pre-trained language model, are updated and adapted for that specific domain, for example through the use of continuous training of the pre-trained language model. And, as described in the optional step 4, the usage of fine-tuned language model may also be suitable for this task of being trained with the augmented data set 7.

As a result of the experiments, the OL classification model gives more successful results on its own test set compared to the dialect test set in terms of classification. In general, it is necessary to add some dialect data samples to the training set to compensate for the decrease in model performance.

### Example

The banking dataset Banking77 was obtained, which is an open dataset of banking inquires under the Creative Commons license (CC-BY-4.0). The Banking77 dataset contains 13,083 queries and 77 classes, or intents, assigned to each inquiry. The Banking77 dataset was Arabized to provide for an official language domain training dataset in the domain of banking inquires. Arabic N-grams were then extracted from the Arabized Banking77 official language domain dataset. In this example, human translators were used to provide for dialect translations of the N-grams extracted from the official language dataset of the Arabized Banking77 dataset. The table of N-grams in the official language and N-grams translated into the dialect formed the dialect translation table. Then the hybrid dataset was created by partially translating sentences containing the N-grams in the official language dataset with the corresponding dialect N-gram using the dialect translation table. This resulted in a hybrid dataset which contained 2,454 queries which were partially translated into the dialect. Then the 2,454 queries that were partially translated into the dialect were added to the Arabized Banking77 dataset resulting in an augmented dataset.

TABLE 1
Augmented dataset containing the Arabized Banking77
dataset and hybrid dataset sentences partially
translated with the dialect translation table

| | |
|---|---|
| Query count | 15,537 |
| Avg word count | 9.85 |
| Min word count | 2 |
| Max word count | 68 |
| Std of word count | 6.54 |

A test dialect D test set was obtained which contained queries in the Arabic dialect. The performance of the dialect D test set of the text classification model trained on the OL training data was recorded as 80.34%. Then the experiments were repeated using the a text classification model trained on the augmented training set. In the new experiments, the results of the dialect D test set increased to 84.96%.

TABLE 2
Statistics of experimental dataset

| Training set for | | |
|---|---|---|
| classification model | Test Set | Model Performance (%) |
| Official Language (OL) | Dialect test set | 80.34 |
| Augmented dataset (AD) | Dialect test set | 84.96 |

As used herein the term “substantially” may mean over 50%, at least 55%, at least 60%, at least, 65%, at least 70%, at least 75%, at least 80%, at least 85%, at least 90%, at least 95%, at least 97.5%, at least 98%, or at least 99%, etc. As used herein, the term “most frequent” would be understood by those skilled in the art to mean a result which occurs at more than a base-line level or that occur more than occasionally. In some embodiments “most frequent” can, for example, refer to the top 10,000 results, top 1,000 results, top 500 results, top 250 results, top 100 results, top 50 results, or top 10 results. In some embodiments term “most frequent” could be expressed in terms of percentages, for example, top 50% of results, 25% of results, top 10% of results, top 5% of results, top 2.5% of results, top 1% of results, top 0.1 percent of results, top 0.01% of results, etc.

What is claimed is:

1. A method of training a text classification model for intent detection in a language dialect, comprising:
obtaining a domain dataset for training the text classification model, wherein the domain dataset is substantially in an official language, wherein the domain dataset contains a plurality of n-grams in the official language, and extracting the plurality of n-grams in the official language from the domain dataset providing an extracted plurality of n-grams in the official language;
creating a dialect language transformation table by providing equivalent dialect words in the language dialect for words in each n-gram of the extracted plurality of n-grams in the official language;
applying the dialect language transformation table to the domain dataset to transform the domain dataset to create a hybrid dataset;
adding the hybrid dataset to the domain dataset to create an augmented dataset; and
training a text classification model using the augmented dataset, thereby producing the trained text classification model for intent detection in the language dialect.

2. The method of training the text classification model for intent detection in the language dialect according to claim 1, further comprising:
fine tuning a pre-trained language model using domain specific sentences adapted to the official language and the dialect language using the dialect transformation table.

3. The method of training the text classification model for intent detection in the language dialect according to claim 2, wherein the step of fine tuning the pre-trained language model using domain specific sentences adapted to the official language and the dialect using the dialect transformation table comprises:
collecting domain specific sentences for training;
using the dialect transformation table by creating combinations of domain specific sentences by replacing matching words and n-grams in the sentences with corresponding ones from the dialect transformation table, wherein each pair of sentences is labeled as entailed sentences;
fine tuning the pre-trained language model for sentence entailment tasks by updating and adapting all parameters of the language model for the specific domain.

4. The method of training the text classification model for intent detection in the language dialect according to claim 1, wherein the official language is Modern Standard Arabic and the dialect language is a dialect of Arabic.

5. The method of training the text classification model for intent detection in the language dialect according to claim 4, wherein the language dialect is Palestinian Arabic, Egyptian Arabic, Mesopotamian Arabic, Sudanese Arabic, Peninsular Arabic, Maghrebi Arabic, or Levantine Arabic.

6. The method of training the text classification model for intent detection in the language dialect according to claim 5, wherein the language dialect is Palestinian Arabic, Egyptian Arabic, Mesopotamian Arabic, Sudanese Arabic, Peninsular Arabic, Maghrebi Arabic, and Levantine Arabic.

7. The method of training the text classification model for intent detection in the language dialect according to claim 1, wherein each n-gram has a 2-, 3-, or 4-word combinations occurring side-by-side in a text of the domain dataset.

8. The method of training the text classification model for intent detection in the language dialect according to claim 1, wherein when the domain dataset comprises n-grams in the language dialect, extracting a plurality of n-grams in the language dialect from the domain dataset providing an extracted plurality of n-grams in the language dialect.

9. The method of training the text classification model for intent detection in the language dialect according to claim 8, wherein creating the dialect transformation table further comprises providing equivalent official language words for words in each n-gram of the extracted plurality of n-grams in the language dialect.

10. The method of training the text classification model for intent detection in the language dialect according to claim 1, wherein the text classification model is a Bidirectional Encoder Representations from Transformers (BERT) model.

11. The method of training the text classification model for intent detection in the language dialect according to claim 2, wherein the text classification model is the fine tuned pre-trained language model.

12. A text classification model for intent detection in a language dialect, wherein the text classification model for intent detection is a text classification model trained according to the method of claim 1.

13. A non-transitory computer readable medium, comprising execution instruction, wherein when a processor of an electronic device executes the instructions, the electronic device performing the method according to claim 1.

14. An electronic device, comprising:
a processor, a memory, and a bus;
wherein the memory is configured to store execution instruction, the processor and the memory are connected through the bus, and when the electronic device runs, the processor executes instructions stored in the memory to cause the processor to perform the method according to claim 1.
